(19) United States
(12) Patent Application Publication
(10) Pub. No.: US 2010/0079738 A1
(43) Pub. Date: Apr. 1, 2010

(54) OPTICAL MEASUREMENT APPARATUS FOR A PROJECTION EXPOSURE SYSTEM

(75) Inventors: Johannes Eisenmenger, Ulm (DE); Thomas Stammler, Aalen (DE); Richard Ell, Aalen (DE)

Correspondence Address: SUGHRUE MION, PLLC, 2100 PENNSYLVANIA AVENUE, N.W., SUITE 800, WASHINGTON, DC, 20037, US

(73) Assignee: Carl Zeiss SMT AG, Oberkochen (DE)

(21) Appl. No.: 12/569,430

(22) Filed: Sep. 29, 2009

Related U.S. Application Data
(60) Provisional application No. 61/101,518, filed on Sep. 30, 2008.

(30) Foreign Application Priority Data
Sep. 30, 2008 (DE) 10 2008 042 463.3

(51) Int. Cl. G03B 27/54; G01J 1/42

(52) U.S. Cl. 355/67; 250/372

(57) ABSTRACT

An optical measurement apparatus (50) for a projection exposure system (10) for microlithography includes an optical sensor (52) that measures a given property of exposure radiation (16) within the projection exposure system (10) and a data interface (66; 166) that transmits at least one value for the measured property in the form of measurement data (60) to a data receiver (72). The data receiver (72) is separated from the measurement apparatus (50) at least during the measuring operation, and is disposed outside of the measurement apparatus (50). The optical measurement apparatus has the outer form of a reticle.

This application claims benefit of U.S. Provisional Application No. 61/101,518, filed Sep. 30, 2008, the full disclosure of which is incorporated into the present application by reference. The present application is also based on German Patent Application No. 10 2008 042 463.3, filed on Sep. 30, 2008, which is also incorporated in full into this application by reference.

### FIELD OF AND BACKGROUND OF THE INVENTION

The invention relates to an optical measurement apparatus for a projection exposure system for microlithography, a measuring system and a projection exposure system respectively comprising this type of measurement apparatus, and a method of performing an optical measurement in a projection exposure system.

A projection exposure system for microlithography generally comprises a number of optical sub-systems. The latter comprise a light source, for example a laser in the UV wavelength range, an illumination system for illuminating a reticle supporting a structured lithography mask, and a projection objective for imaging the lithography mask onto a varnished semiconductor wafer. Therefore, the optical path of the electromagnetic radiation produced by the light source typically extends through the illumination system, the reticle and the projection objective.

If by means of the projection exposure system resolutions within the nanometer range are to be achieved, high demands are made especially of the illumination of the reticle. In this case the intensity distribution in the pupil plane of the illumination system is not homogeneous. In fact, the illumination of the reticle is not implemented with the perpendicular incidence of light, but e.g. in the form of a dipolar, annular or even more complex angular distribution of the direction of incidence of the light rays. For this purpose, various optical elements are provided in the illumination optical path with which the illumination of the reticle can be optimised. However, there is the problem that as the complexity of the adjustment possibilities increases, the long-term stability of the illumination setting decreases. In order to prevent this, currently, during operation of the projection exposure system the radiation arriving in the wafer plane is measured by means of a sensor system located here, and from this measurement the illumination distribution is deduced.

With regard to this, however, certain suppositions must be made concerning the imaging properties of the projection objective which narrows the significance of such measurements. A measurement taken directly in the reticle plane will fail however due to the small amount of space available for installation of this type of sensor system along with the electric cables and data cables required for the latter.

### SUMMARY OF THE INVENTION

It is an object of the invention to specify a projection exposure system and a method for implementing an optical measurement with which the problems specified above can be overcome, and in particular the course of the exposure radiation in the optical path of the projection exposure system can be determined more accurately and more comprehensively.

According to one formulation of the invention, an optical measurement apparatus for a projection exposure system for microlithography is provided. This measurement apparatus comprises an optical sensor for measuring a property of exposure radiation within the projection exposure system and a data interface which is configured to transmit the measured property in the form of measurement data to a data receiver separated from the measurement apparatus, at least during the measuring operation, and disposed outside of the measurement apparatus. Within the context of the application, separated means in particular that there is no line-bound connection between the measurement apparatus and the data receiver. Therefore, no physical line is provided between the measurement apparatus and the data receiver. In particular therefore there is no galvanic, i.e. electrically conductive, or fibre-optic connection line.

According to a further aspect of the invention, the optical measurement apparatus has the outer form of a reticle. At the very least the outer form or shape of the measurement apparatus should be configured such that the latter can be accommodated like a reticle by the reticle stage of the projection exposure system. This way, the measurement apparatus can be inserted into the reticle stage of the projection exposure system instead of a product reticle by means of the reticle changer.

Moreover, according to the invention a measuring system is provided with this type of optical measurement apparatus and a data receiver disposed outside of the measurement apparatus. Furthermore, the invention makes provision for a projection exposure system for microlithography with this type of measurement apparatus. In one embodiment according to the invention the measurement apparatus is disposed in an optical path of the projection exposure system guiding the exposure radiation. In a further embodiment the projection exposure system is configured to operate within the EUV wavelength range.

According to another formulation of the invention, a method is provided of performing an optical measurement in a projection exposure system for microlithography. The exposure system comprises a wafer plane and an optical path for guiding exposure radiation onto a wafer arranged in the wafer plane. The method comprises the step of arranging a cordless optical measurement apparatus within the optical path of the projection exposure system at a position above the wafer plane. The optical measurement apparatus comprises an optical sensor and a data interface. The method according to the invention further comprises the steps of: measuring a property of the exposure radiation within the projection exposure system by means of the optical sensor, and transmitting the property measured in the form of measurement data by means of the data interface to a data receiver separated from the measurement apparatus, at least during the measuring operation. The data receiver is disposed outside of the measurement apparatus. The optical path of the projection exposure system comprises an optical path within an illumination system and an optical path within a projection objective of the projection exposure system. The arrangement of the optical measurement apparatus above the wafer plane means, that the measurement apparatus is arranged at a position closer to the reticle plane than the wafer plane of the projection exposure system. According to an embodiment the measurement apparatus is arranged at least 1 mm above the wafer plane.

The data interface according to the invention can be configured in one embodiment as a data transmitter, e.g. as a radio transmitter, for the contact-free transmission of the measurement data to the external data receiver. In another embodiment the data interface can be configured as a contact interface, it being possible to read out the measurement data stored within the data memory by means of mechanical contacting of the contact interface with the data receiver. The contact interface can be in the form e.g. of a plug interface for accommodating a plug of a data cable. For this purpose e.g. a USB interface can be considered.

By means of the provision according to the invention of a data interface which is configured to transmit the measurement data to a data receiver which is separated from the measurement apparatus, at least during the measurement operation, and which is therefore external, the measurement apparatus can be introduced during a short exposure pause into the optical path of the projection exposure system, and the measurement can be performed. Cable connections for transmitting the measurement data which if required would make a structural adaptation of the projection exposure system necessary, are not necessary. In fact, the measurement data are either transmitted, contact-free, to the data receiver during the measurement or read out from the measurement apparatus which has been removed again from the projection exposure system after the measurement.

In particular, with the data interface according to the invention it is possible to use the measurement apparatus for measuring in exchange with a removable element of the projection exposure system. This type of removable element can be, for example, a reticle masking diaphragm, an illumination aperture diaphragm, a reticle, an exchangeable polarisation-defining element, e.g. a polarisation filter, or a diffractive element in the illumination system, as explained in greater detail below. Other removable elements can comprise plane plates and wavefront correction elements. Therefore, the measurement apparatus according to the invention enables the measurement of the exposure radiation at different positions of the optical path which are not accessible to a measurement apparatus installed in a fixed position or to a measurement apparatus equipped with data transmission cables due to the amount of space required for this. It is therefore possible, for example, to determine the intensity distribution in the reticle plane, angularly resolved, and so to check the stability of the illumination setting without the effect of the projection optics, and so with great precision. Further, polarisation properties of the exposure radiation, especially of the illumination radiation, can be determined using the measurement apparatus. The illumination radiation is radiation generated by the illumination system to illuminate the reticle plane.

The measurement apparatus according to the invention can therefore be configured such it can be used without any structural changes to the projection exposure system. Therefore, the measurement apparatus can be used in particular in projection exposure systems made by different manufacturers. The measuring system according to the invention with the optical measurement apparatus and the external data receiver can therefore be used for measuring projection exposure systems which have already been installed.

In an embodiment according to the invention the optical measurement apparatus is used to calibrate the projection exposure system in a closed calibration loop. For example the optical measurement apparatus having the outer form of a reticle as described above and configured to measure the illumination setting of the illumination system, also referred to as sigma setting can be used for such a closed calibration loop. Here, every time a new illumination setting is adjusted the optical measurement apparatus may be moved into the reticle plane to check the angular illumination distribution generated by the new setting. Alternatively or additionally the calibration can be performed at given time intervals.

In one embodiment according to the invention the measurement apparatus according to the invention further comprises a data memory for storing the measurement data. In the case of data transmission of the measurement data by means of a data transmitter to the data receiver during the measurement process the data memory can act as a buffer in order to buffer a limited data transmission rate of the data transmitter by intermittent intermediate storage of the measurement data. In the case of data transmission following the measuring process, for example by means of the contact interface, the measurement data can be stored totally in the data memory until read out.

In a further embodiment according to the invention the optical measurement apparatus further comprises the aforementioned data memory and a control device which is configured to first of all transmit the measurement data determined by the optical sensor to the data memory for intermediate storage, and then to read out the measurement data again from the data memory and forward them to the data interface for transmission to the data receiver.

In a further embodiment according to the invention the data transmitter comprises a radio transmitter, as already mentioned above. In this case the data is transmitted to the data receiver by means of radio waves.

In a further embodiment according to the invention the data transmitter has a radiation source for producing electromagnetic radiation in the infrared and/or higher frequency wavelength range. For example, the data transmitter can be configured for example as a laser diode.

In a further embodiment according to the invention the data transmitter is configured to transmit the measurement data by means of a sequence of different magnetic field strengths to the data receiver disposed in the near field of the magnetic field. Thus, the data transmission is not implemented by the propagation of an electromagnetic carrier wave into the far field, but by direct measurement of a sequence of different magnetic field strengths and/or directions within the near range of the data transmitter. The temporal variation of the magnetic field strength and direction is arbitrary. The measurement data can be transmitted e.g. by switching the magnetic field on and off in a specific temporal sequence. For example, in particular, a change of the magnetic field strength at the location of the data receiver is measured for example by a change of the induced voltage. The time frame within which the magnetic field in this case remains at a constant value can be, for example several milliseconds. Alternatively, the measurement data can also be transmitted by a continuous variation of the magnetic field. The data transmitter can be provided to produce the magnetic field with an element through which current flows, e.g. a magnetic coil, or also by means of a permanent magnet in association with a movement device for the mechanical movement of the permanent magnet. By tilting the permanent magnet the magnetic field can then be varied at the location of the data receiver.

In a further embodiment according to the invention the data transmitter is configured to transmit the measurement data to the data receiver disposed in the near field of the electric field by means of a sequence of different electric field strengths. Therefore, the measurement data can be transmitted by means of a sequence of different electric field strengths. Therefore, the data are not transmitted by the propagation of an electromagnetic carrier wave into the near field, but by direct measurement of a sequence of different electric field strengths and/or directions in the near range of the data transmitter. The temporal variation of the electric field strength and direction is arbitrary. The measurement data can e.g. be transmitted by switching the electric field on and off in a specific temporal sequence. The time frame within which in this case the electric field remains at a constant value can be, for example, a few milliseconds. Alternatively the measurement data can also be transmitted by a continuous variation of the electric field. In order to produce the electric field with an electrically chargeable conductive element (e.g. a metallic capacitor plate) or also by means of an electrostatically charged insulating element (e.g. glass surface with surface charges), the data transmitter can be provided in association with a movement device for moving the element mechanically. By tilting the element the electrical field can then be varied at the location of the data receiver.

In a further embodiment according to the invention the data transmitter comprises a sound source. The sound source can comprise an electrostatic loudspeaker or a piezo loudspeaker, and in particular be in the form of an ultrasonic generator.

In a further embodiment according to the invention the optical measurement apparatus further comprises a current source for supplying the data transmitter with electric current. In one embodiment the current source is configured as an energy store for storing electrical energy. The energy store can for example be in the form of a battery, accumulator and/or capacitor. In a further embodiment the current source comprises an energy converter for converting chemical reaction energy into electric current. For this type of energy converter e.g. a fuel cell can be considered.

In a further embodiment according to the invention the current source comprises an energy receiver for receiving energy transmitted contact-free. In one embodiment the energy receiver can comprise a radio wave receiver. In a further embodiment the energy receiver comprises a photodiode for the infrared and/or higher frequency wavelength range. Moreover, the energy receiver can comprise a magnetic coil for receiving energy from an alternating magnetic field. In a further embodiment the energy receiver comprises a sound wave receiver. The latter serves to convert the mechanical energy of the sound waves into electrical energy.

In a further embodiment according to the invention the optical measurement apparatus has the outer form of a diffractive optical element or of a polarisation-changing element, such as for example a polariser. In particular, the outer form of the measurement apparatus corresponds to the outer form of a removable diffractive optical element or of a removable polarisation-changing element of the optics, in particular of the illumination system of the projection exposure system. Therefore, the measurement apparatus can be inserted into the optical path of the projection exposure system instead of a diffractive optical element or polarisation-changing element of this type. As already mentioned above, further elements removable from the optical path of the projection exposure system can comprise plane plates or wavefront correction elements. Advantageously, the optical measurement apparatus has the outer form of this type of plane plate or of this type of correction element.

In a further embodiment according to the invention the optical sensor is configured as a locally resolving electro-optical detector, such as e.g. a CCD array. Therefore, a two-dimensional intensity distribution of the irradiated exposure radiation can be determined as the property measured by the measurement apparatus. In certain embodiments the optical measurement apparatus comprises micro optics. Further, the optical measurement apparatus may comprise diffractive structures, e.g. in the form of computer generated holograms (CGHs). According to a further embodiment the optical measurement apparatus comprises at least one optical prism and/or at least one diffractive grating for breaking up the exposure radiation into its spectral components. With such an optical measurement apparatus a spectral analysis of the exposure radiation may be performed. According to a variation the spectral distribution of the illumination radiation generated by the illumination system of the projection exposure system, in particular having wavelengths in the EUV-wavelength range, is analysed using such an optical measurement system.

In a further embodiment according to the invention the optical sensor is configured as a wavefront measurement device. The property of the exposure radiation measured by the measurement apparatus is therefore the wavefront of the latter. For this purpose the optical sensor can be in the form e.g. of a Shack-Hartmann sensor or of another, in particular interferometric, wavefront measurement device known to the person skilled in the art.

In a further embodiment according to the invention the optical sensor is configured to determine the intensity of the irradiated exposure radiation, directionally resolved. For this purpose the optical sensor can also be configured in the manner of a Shack-Hartmann sensor the signals of which are specially evaluated, as described in greater detail below. The property measured is then a directionally-resolved intensity distribution of the irradiated exposure radiation.

In a further embodiment according to the invention the optical sensor is configured as a polarisation sensor. Therefore, the intensity of the exposure radiation having a specific polarisation can be measured, in particular the respective intensity of the individual portions corresponding to different polarisation components.

In a further embodiment according to the invention the optical sensor is configured for the detection of exposure radiation within the extreme ultraviolet (EUV) wavelength range, in particular within the wavelength range smaller than 100 nm. Therefore, EUV projection exposure systems can be measured according to the invention.

In a further embodiment according to the invention the optical measurement apparatus further comprises a signal receiver for receiving control signals transmitted contact-free from outside of the optical measurement apparatus which serve to control the measurement apparatus. Therewith, the measurement can be controlled from outside by the measurement apparatus introduced into the optical path of the projection exposure system. For the contact-free transmission of the control signals all of the transmission types mentioned above with regard to the transmission of measurement data from the data transmitter to the data receiver can be considered. Advantageously the measuring system according to the invention has a signal transmitter disposed outside of the measurement apparatus for transmitting control signals.

In a further embodiment the optical measurement apparatus according to the invention is used to determine the telecentricity of the projection objective or an imaging module of the illumination system of interest. According to a further embodiment the optical measuring apparatus is used to determine the uniformity of the lithographic exposure. A further property to be measured may be the amount of speckle within the projection exposure system. Further, a measurement of micro-uniformity of the lithographic exposure may be performed. According to a further embodiment the optical measurement apparatus is used to perform a scattered light measurement at the projection exposure system.

In an embodiment according to the invention the projection exposure system comprises an illumination system for illuminating a mask to be imaged into the wafer plane, and the optical measurement apparatus is arranged inside the illumination system for performing a measurement. According to a further embodiment the optical measurement apparatus is arranged in a pupil plane of the projection objective of the projection exposure system.

In certain embodiments according to the invention the optical measurement system is arranged in the optical path of the projection exposure system in exchange with a mechanically exchangeable optical element of the projection exposure system, e.g. a mechanically exchangeable optical element of the illumination system.

The features specified with regard to the embodiments of the optical measurement apparatus according to the invention mentioned above can correspondingly be transferred to the method according to the invention, and vice versa. The resulting embodiments of the method according to the invention are to be explicitly included by the disclosure of the invention. Especially the cordless optical measurement apparatus arranged within the optical path of the projection exposure system according to the method of performing an optical measurement described above may be configured according to any of the embodiments of the optical measurement apparatus described previously.

### BRIEF DESCRIPTION OF THE DRAWINGS

In the following exemplary embodiments of an optical measurement apparatus according to the invention for a projection exposure system for microlithography is described in greater detail by means of the attached schematic drawings. These show as follows:

FIG. 1 an illustration of a structure, in principle, of an embodiment of a projection exposure system according to the invention with an optical measurement apparatus according to the invention, in the figure the measurement apparatus being drawn in at various possible locations of operation in the optical path of the projection exposure system,

FIG. 2 a schematic top view of the optical measurement apparatus according to FIG. 1 in a first embodiment according to the invention,

FIG. 3 a greatly schematised side view of the optical measurement apparatus in an alternative embodiment according to the invention,

FIG. 4 a schematic sectional view of an optical sensor of the measurement apparatus according to FIG. 2 or FIG. 3,

FIG. 5 a schematic sectional view of the optical measurement apparatus according to FIG. 2 or FIG. 3 which is additionally provided with an optical module which is designed e.g. to change the imaging scale or as Fourier optics for transforming of angle into location,

FIG. 6 a schematic sectional view of the optical sensor in a further embodiment according to the invention, and

FIG. 7 a three-dimensional view of the outer form of the optical measurement apparatus according to any of the preceding embodiments.

### DETAILED DESCRIPTION OF EXEMPLARY EMBODIMENTS

In the exemplary embodiments described below elements which are functionally or structurally similar to one another are provided as far as possible with the same or similar reference numbers. Therefore, in order to understand the features of the individual elements of a specific exemplary embodiment one should refer to the description of other exemplary embodiments or to the general description of the invention.

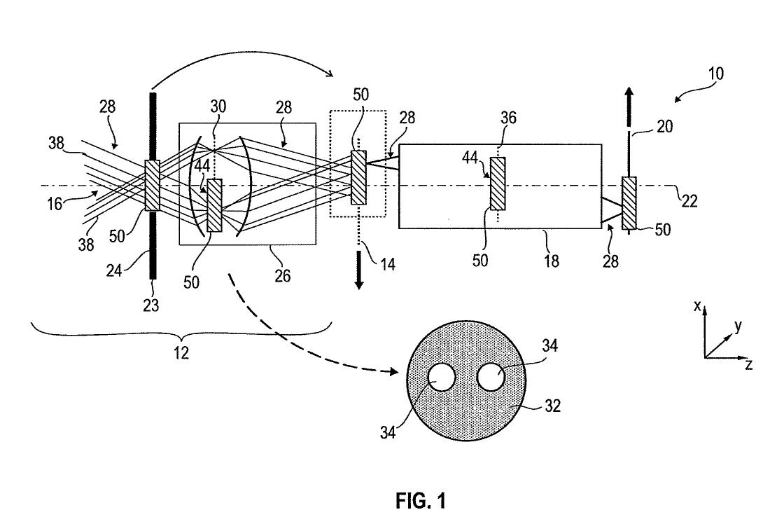

FIG. 1 shows an exemplary embodiment of a projection exposure system 10 according to the invention for microlithography, here in the form of a scanner. The projection exposure system 10 comprises an illumination system 12 for illuminating a reticle disposed in a reticle plane 14 of the projection exposure system 10. The reticle is not shown in FIG. 1. The illumination of the reticle is performed with electromagnetic exposure radiation 16 with a specific wavelength which, depending on the type of projection exposure system 10, can come within the UV wavelength range or within the EUV wavelength range (extreme ultraviolet radiation with a wavelength of less than 100 nm, for example 13.4 nm). Within the UV wavelength range the wavelength can be for example 365 nm, 248 nm, 193 nm or 157 nm.

The projection exposure system 10 further comprises a projection objective 18 and a wafer plane 20. Mask structures in the reticle palne 14 are imaged into the wafer plane 20 by means of the projection objective 18. The illumination system 12 and the projection objective 18 have a common optical axis 22. A radiation source not shown in the drawing, for example a laser or a plasma source for producing the exposure radiation 16 is positioned in front of the illumination system 12. The illumination system 12 comprises a reticle masking device 24 (REMA) disposed in a diaphragm plane 23 for limiting an illuminated region in the reticle plane 14. For this purpose the reticle masking device 24 has for example adjustable diaphragms—so-called REMA blades. Furthermore, the illumination system 12 comprises a REMA objective 26 for imaging the reticle masking device 24 into the reticle plane 14.

The optical path of the exposure radiation 16 produced by the radiation source therefore extends through the diaphragm plane 23, the REMA objective 26, the reticle plane 14 and the projection objective 18, and ends in the wafer plane 20. The REMA objective 26 has a pupil plane 30. Depending on the design of the optics, an illumination aperture diaphragm 32 can be provided in the pupil plane 30 of the REMA objective 26. This type of illumination aperture diaphragm 32 is illustrated schematically in the example of a diaphragm producing a dipolar angular distribution of the illumination radiation in the reticle plane 14 in the bottom section of FIG. 1.

The illumination aperture diaphragm 32 shown has two recesses 34 in the form of circular areas for the passage of the electromagnetic radiation 16. The illumination aperture diaphragm 32 is mounted exchangeably. The projection exposure system 10 has a diaphragm archive from which, depending on the illumination requirement during production operation, the appropriate illumination aperture diaphraghm 32 is removed and disposed in the pupil plane 30 of the REMA objective 30. Illumination aperture diaphragms mounted in the diaphragm archive can for example serve to produce annular illumination, quadrupole illumination or more complex forms of illumination in the reticle plane 14. Depending on the design of the illumination optics 12, in addition to the illumination aperture diaphragms, other beam-forming optical elements can be used to form the desired illumination distribution in the reticle plane 14.

In this context the pupil of an optical system, such as for example the aforementioned REMA objective, is understood in particular as meaning the outlet pupil of the optical system. Every optical system has an aperture diaphragm regulating the brightness of the image. In the case of a lens this can be formed by the edge of the lens or also a disc diaphragm disposed behind the optical elements of a multi-lens system. The outlet pupil of an optical system is the image of the aperture diaphragm disposed in the aforementioned pupil plane, as viewed from an axial point of the image plane by means of lenses of the optical system lying between the aperture diaphragm and the point in the image plane.

According to the invention an optical measurement apparatus 50 is disposed in the optical path 28 of the projection exposure system 10 in one of the embodiments described below. FIG. 1 shows as examples a number of possible arrangement positions for the measurement apparatus 50. The measurement apparatus 50 can therefore be disposed for example in the diaphragm plane 23, in the pupil plane 30 of the REMA objective 26 and therefore inside the illumination system 12, in the reticle plane 14, in a pupil plane 36 of the projection objective 18 or else in the wafer plane 20. In particular, the optical measurement apparatus 50 can be disposed in all of the planes of the optical path 28 in which mechanically exchangeable elements are located during lithographic operation of the projection exposure system 10, respectively in exchange with the mechanically exchangeable element. For this purpose the aforementioned planes are particularly suitable.

Therefore, the measurement apparatus 50 can be disposed for example in an exposure pause instead of a diaphragm in the diaphragm plane 23. For this purpose the diaphragm is removed mechanically from the optical path 28 and the measurement apparatus 50 is introduced instead of the latter. Here, in an embodiment according to the invention, the measurement apparatus 50 has the outer form of this type of diaphragm. The measurement apparatus 50 can then be disposed in the diaphragm plane 23 by means of a mechanism for exchanging the diaphragm already provided in the projection exposure system 10.

Alternatively, the measurement apparatus 50 can be disposed in the pupil plane 30 of the REMA objective 26 by means of a mechanism for exchanging the illumination aperture diaphragms 32 already provided in the projection exposure system 10 instead of this type of illumination aperture diaphragm. For this purpose it is particularly advantageous to design the measurement apparatus 50 such that it has the outer form of an illumination aperture diaphragm.

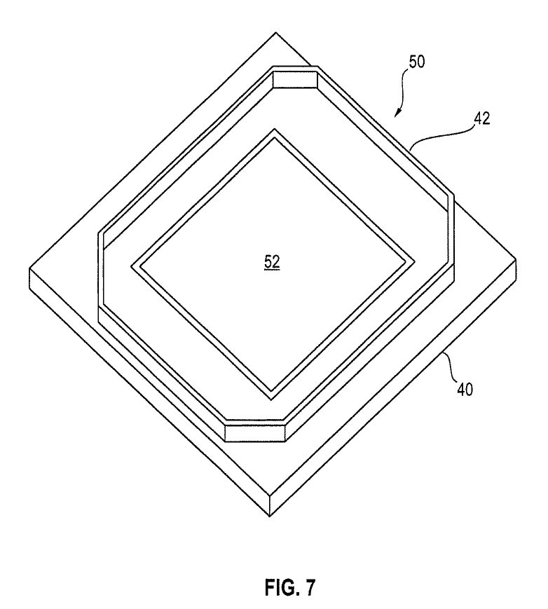

Furthermore, the measurement apparatus 50 can be disposed in the reticle plane 14. This can be implemented by means of a reticle changer of the projection exposure system 10. For this purpose, in one embodiment according to the invention, the measurement apparatus 50 has the outer form of a reticle, as shown in FIG. 7. The measurement apparatus 50 according to FIG. 7 has a base body 40 which corresponds, as regards its dimensioning, to the transparent base plate of a product reticle. Disposed on the top side of the base body 40, in a central rectangular region, is an optical sensor 52 described in greater detail below. The rectangular region corresponds to a region of a product reticle in which the mask structures to be imaged are disposed.

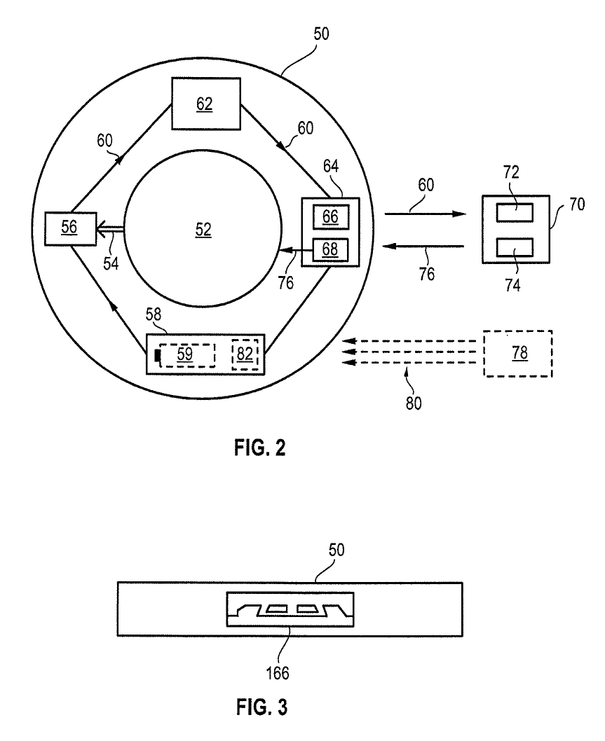

Furthermore, the measurement apparatus 50 can also comprise an optional pellicle frame 42 with a pellicle clamped with the latter. In the region of the pellicle frame outside of the optical sensor 52 further structural elements of the measurement apparatus 50 can also be disposed. These types of further structural elements of the measurement apparatus 50 are described in greater detail below, in particular with reference to FIG. 2.

In a further embodiment according to the invention the measurement apparatus 50 can be disposed in the pupil plane 36 of the projection objective 18 or the wafer plane 20. In the case of it being disposed in the wafer plane 20, in one embodiment according to the invention the measurement apparatus 50 has for example the outer form of a wafer, i.e. it is in the form of a disc having for example a diameter of 300 mm and a thickness of several 100 μm to several mm. The dimensioning of the disc should be matched to the wafer feed system in the projection exposure system 10 so that the measurement apparatus 50 can be loaded instead of a wafer into the wafer plane 20 in order to perform the optical measurement. Alternatively, however, it can also be a different element which can be accommodated by the wafer stage, e.g. at its corners. In case of arrangement of the measurement apparatus 50 in the wafer plane 20, for example the so-called uniformity of the lithographic exposure can be measured.

Alternatively, the measurement apparatus 50 can correspond in its outer form to another exchangeable element of the optical path 28 of the projection exposure system 10. This type of exchangeable element can be, e.g. dependently upon the design of the optics of the projection exposure system 10, an exchangeable polarisation-defining element, e.g. a polarisation filter, or an exchangeable diffractive optical element of the illumination system 12.

FIG. 2 illustrates the individual components of an embodiment of the measurement apparatus 50 according to the invention. The measurement apparatus 50 shown in FIG. 2 is designed in its outer form as a disc, for example for use in the wafer plane 20. Located in the centre of the measurement apparatus 50 is an optical sensor 52, for example in the form of a locally-resolving electro-optical detector, such as for example a CCD array. The optical sensor can, as shown in FIG. 2, be circular in design or of some other shape, such as for example rectangular.

The optical sensor 52 measures a property of the exposure radiation 16 in the optical path 28 of the projection exposure system 10. The property measured can, for example in the case where the optical sensor 52 is configured as a locally resolving detector, be a two-dimensional intensity distribution of the exposure radiation 16 in the corresponding measuring plane. Alternatively, the measured property can be a locally and/or angularly resolved intensity distribution, a wavefront and/or a polarisation distribution of the exposure radiation 16, as described in greater detail below.

The measurement apparatus 50 further comprises a signal processing device 56, an optical data memory 62, a transmitting/receiving module 64 and a current source 58. The property measured by the optical sensor 52 is transmitted to the signal processing device 56 in the form of a measurement signal 54. The signal processing device 56 converts the measurement signal 54 into measurement data 60 which are transmitted either directly to a data interface integrated into the transmitting/receiving module 64 in the form of a data transmitter 66, or they are first of all intermediately stored in the data memory 62 serving as a buffer. In the latterly mentioned case the measurement data 60 are read out from the data memory 62 by the data transmitter 66 according to the transmission rate of the latter. The data transmitter 66 is configured for contact-free transmission of the measurement data 60 to an external data receiver 72. The data receiver 72 can form part of a transmitting/receiving module 70 disposed outside of the projection exposure system 10.

In one embodiment according to the invention the data transmitter 66 is configured as a radio transmitter and serves to transmit data to the data receiver 72 by means of radio waves. The data transmitter 66 can also be configured as an infrared transmitter, and the data receiver 72 as a corresponding infrared receiver. Furthermore, transmitters 66 and receivers 72 can also be designed to transmit data with optical radiation of higher frequency.

In a further embodiment according to the invention the data transmitter 66 has an element through which current flows, e.g. a magnetic coil or a permanent magnet for producing a magnetic field with a field strength such that the magnetic field can be detected with a temporally constant field strength at the location of the data receiver. The measurement data are then transmitted by means of a sequence of different magnetic field strengths. In this case the data receiver 72 is configured as a magnetic field detector for measuring the magnetic field strength at the location of the data receiver 72. The transmission of the measurement data 60 is implemented by means of a variation in the strength and/or the direction of the magnetic filed produced by the data transmitter 66. In particular, the data transmission can for example be implemented by switching the magnetic field on and off in a specific temporal sequence. In the case where the data transmitter 66 comprises a permanent magnet, a variation of the magnetic field strength can be implemented by mechanically tilting the permanent magnet. Furthermore, as described in greater detail above, the data transmitter can comprise an electrically chargeable conductive element, e.g. a metallic capacitor plate, and be configured to produce an electric field with a field strength such that with a temporally constant field strength the electric field can be detected at the location of the data receiver. The data receiver can then be configured as a corresponding field strength sensor, e.g. as a Faraday sensor.

Alternatively, the data transmitter 66 can be configured as a sound source, in particular as an ultrasonic generator, and the data receiver 72 as a corresponding sound receiver. In this case the measurement data 60 are transmitted by means of sound waves.

The transmitting/receiving module 64 of the optical measurement apparatus 50 can further comprise a signal receiver 68 for receiving control signals 76 which are transmitted by a signal transmitter 74 of the external transmitting/receiving module 70. The control signals serve to control the operation of the optical sensor 52, in particular to control the recording period for recording the property of the exposure radiation 16 to be measured. The transmission of the control signals 76 can be implemented in all of the transmission types described above with regard to the transmission of the measurement data.

However, the measurement apparatus 50 can also be configured without this type of signal receiver 68. In this case the module 64 only has the data transmitter 66. Correspondingly, the module 70 is also configured without the signal transmitter. If the measurement apparatus 50 does not contain any signal receiver 68, the control of the sensor 52 can take place e.g. according to a pre-specified algorithm or be configured such that the measurement apparatus 50 continuously records current measurement data 60 and transfers them to the data receiver 72.

As already mentioned above, the measurement apparatus 50 further comprises a current source 58 for supplying the data transmitter 66 with electric current. If required the current source 58 also supplies the signal processing device 56, the data memory 62 and the signal receiver 68 with electric current. According to the invention the current source 58 can be designed in various embodiments. In a first embodiment the current source 58 comprises an energy store 59 for storing electrical energy, e.g. in the form of a battery, an accumulator or a capacitor. In a further embodiment the current source 58 comprises an energy converter, e.g. in the form of a fuel cell, for converting chemical reaction energy into electric current.

In a further embodiment the current source 58 comprises an energy receiver 82 for receiving energy 80 transmitted contact-free by an external energy transmitter 78. The contact-free energy transmission can be implemented e.g. by means of radio waves, by means of infrared radiation or higher frequency optical radiation, by inductively or capacitively coupled energy transmission by means of a magnetic or electric alternating field in the same way as a magnetic socket or by means of sound waves. The energy receiver 82 then has, dependently upon the foam of the energy transmission, a radio wave receiver, a photodiode, an inductivity, a capacitance or a sound wave receiver for converting the sound waves into electrical energy.

FIG. 3 shows a side view of a further embodiment of the measurement apparatus 50. This is designed in the same way as the measurement apparatus 50 according to FIG. 2, but with the exception that the data interface is not configured as a data transmitter 66, but as a contact interface 166. The contact interface 166 is e.g. in the form of a socket for plugging in a data cable, in particular as a socket for plugging in a USB plug.

During operation of the measurement apparatus 50 according to FIG. 3, during the measurement in the projection exposure system 10 the measurement data 60 are first of all stored totally in the data memory 62. After completion of the measurement the measurement apparatus 50 is removed again from the projection exposure system 10 and the stored measurement data 60 are then read out from the contact interface 166 by mechanical contacting by means of the data receiver 74.

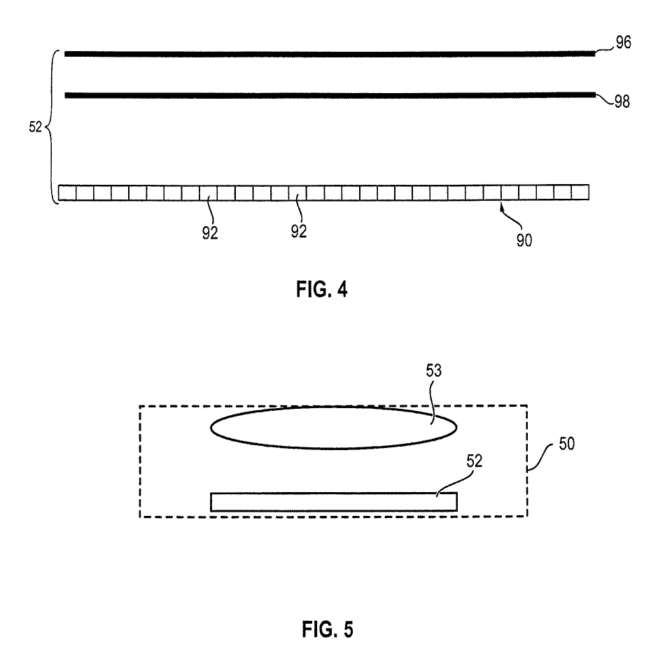

FIG. 4 shows a first embodiment of the optical sensor 52. The latter has a two-dimensionally locally resolving electro-optical detector 90 in the form of a CCD array. The detector 90 has a grid of individual detector elements 92. Therewith a two-dimensional intensity distribution of the exposure radiation 16 can be recorded as a measured property in the corresponding plane of the projection exposure system 10. In addition, the optical sensor 52 can comprise an optional polarisation-defining element 96, e.g. a polarisation filter, a λ/2 plate, a λ/4 plate or a combination of the latter, and/or an optional spectral filter 98, respectively disposed in the optical path in front of the detector 90. Therefore, the intensity of the exposure radiation 16 can be measured dependently upon its polarisation or its wavelength. In particular the polarisation property of the radiation 16 coming from the illumination system 12, i.e. the so-called illumination radiation, may be measured when arranging the measurement system 50 appropriately.

If during the measurement the filters 96 and 98 are replaced by filters with different polarisation or different spectral permeability, the exposure radiation 16 can be totally characterised with regard to its polarisation and its spectral composition. The filters 96 and 98 can form part of a rotating filter wheel with which by turning about a vertical axis of rotation filters with different properties can be placed over the detector 90. Alternatively, the radiation detector 90 can also be designed to be polarisation-selective or wavelength-selective.

According to an embodiment not depicted in the drawings the optical sensor 52 may comprise optical prisms and/or diffraction gratings for breaking up the exposure radiation 16 into its spectral components. With such a measurement apparatus 50 a spectral analysis of the exposure radiation 16 at a location of interest within the optical optical path 28 of the projection exposure system 10 may be performed. According to another embodiment the optical sensor 52 configured for spectral analysis is arranged at a location, at which the spectral intensity distribution of the radiation 16 generated by the illumination system 12, i.e. the illumination radiation, can be measured. According to a variation the optical sensor 52 is configured for spectral analysis of radiation in the EUV wavelength range.

FIG. 5 shows an embodiment of the measurement apparatus 50 with which an optical module 53 is disposed over the optical sensor 52 which is designed e.g. to change the imaging criterion or is designed as Fourier optics for the transformation of angle into location. The optical module 53 can comprise one or more refractive, diffractive and/or reflective elements. In a further embodiment the measurement apparatus 50 comprises additional diaphragms.

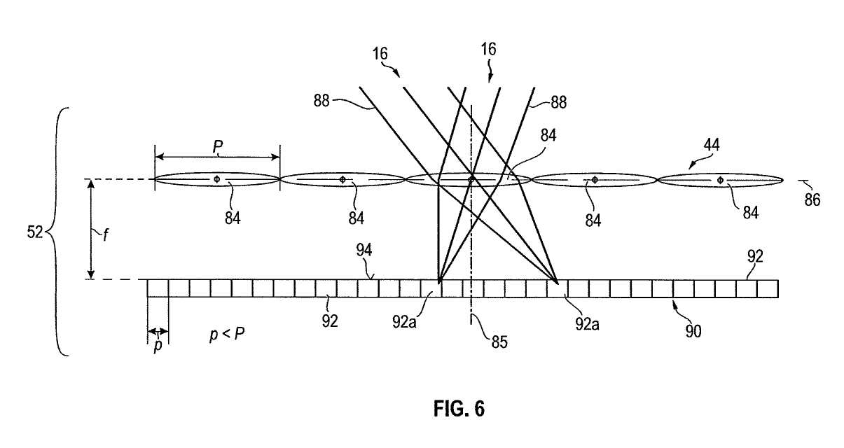

FIG. 6 illustrates an embodiment of the optical sensor 52 with which the intensity distribution of the exposure radiation 16 can be recorded locally or angularly resolved. Furthermore, with this optical sensor 52 or in general with a Shack-Hartmann sensor it is possible to measure the wavefront of the irradiated exposure radiation 16.

The individual rays 88 of the exposure radiation 16 drawn in as an example in FIG. 6 illustrate the situation with an exemplary embodiment of the measurement apparatus 50 in the pupil plane 30 of the REMA objective 26. Here the individual rays 88 strike respective points of a measuring field 44 of the measurement apparatus 50 at different angles. The measurement apparatus 50 is set up to record the striking radiation, angularly resolved, at different points of the measuring field 44, as described in greater detail below, i.e. for each of the individual points in the measuring field 44 an angularly resolved irradiation strength distribution is determined. Therefore, it is possible to determine the radiation intensities irradiated with different incident angles at the respective points in the pupil plane 30.

When arranging the measurement apparatus 50 such that the optical sensor 52 is located in the reticle plane 14 of the projection exposure system 12 the illumination setting, i.e. the angular distribution of the illumination rays in the reticle plane 14, can be checked. The measurement of the illumination setting using the measurement apparatus 50 can be performed as part of a closed loop calibration routine every time when a new illumination setting is adjusted or simply at fixed time intervals.

The optical sensor 52 according to FIG. 6 has in a measuring plane 86 the measuring field 44 with an arrangement of focussing optical elements 42. In the case illustrated the focussing optical elements 84 are configured as micro optics and form a microlens grid. Here the focussing optical elements 84 are in the form of refractive microlenses. The focussing optical elements 84 can however also be designed as diffractive microlenses, for example in the form of CGHs (Computer Generated Holograms) or as pinholes. The focussing optical elements 42 have a uniform focal width f and so a common image plane and a common focus plane.

The measurement apparatus 50 further comprises a locally resolving radiation detector 90 in the form of a CCD camera or of a two-dimensional photodiode grid. The locally resolving radiation detector 90 has a recording surface 94 facing towards the focussing optical elements 84. The recording surface 94 is disposed here in the common image plane of the focussing optical elements 84. The locally resolving radiation detector 90 comprises a plurality of detector elements 92 with a respective extension p in a direction parallel to the recording surface 94. Therefore, the extension p defines the local resolution of the radiation detector 90.

Exposure radiation 16 falling onto the measuring field of the measurement apparatus 36, which is called incident radiation here, is focussed onto the recording surface 94 of the radiation detector 90 by means of the focussing optical elements 84. Here all of the individual rays 88 of the incident radiation 16 which have the same angle a in relation to the optical axis 85 of the illuminated optical element 42 in question, are focussed onto a specific detector element 92. The radiation intensity arriving at a detector element 92a illuminated in this way is registered by the radiation detector 90.

By means of the signal processing device 56, from the local distribution of the registered intensity on the recording surface 92 of the radiation detector 90 the locally and angularly resolved irradiation strength distribution in the measuring plane 86 of the measurement apparatus 50 is reconstructed. For this purpose the detector elements 92 lying respectively directly beneath corresponding focussing optical elements 84 are assigned to the respective optical elements 84. So that no “crosstalk” occurs, i.e. the case does not occur whereby incident radiation passing through a specific focussing optical element 84 falls on a detector element 92 assigned to an adjacent focussing element 84, the maximum angle of incidence αₘₐₓ of the incident radiation 16 is limited such that the following relation is fulfilled:

P/(2f)>tan(αₘₐₓ),

P being the diameter and f being the focal width of the focussing optical elements 84.

Therefore, the irradiation strength distribution in the measuring field 44 of the measurement apparatus 50 can be respectively determined two-dimensionally, locally and angularly resolved, from the intensity distribution recorded by the radiation detector 90. The local resolution is limited by the diameter P of the focussing optical elements 84. The location allocation of radiation passing through a specific focussing optical element 84 takes place via the centre point of the corresponding focussing optical element 84.

In the embodiment according to FIG. 6 the measurement apparatus 50 corresponding to the measurement apparatus according to FIG. 4 optionally comprises a polarisation-defining element 96, e.g. a polarisation filter and/or a spectral filter 98. Therefore the irradiation strength distribution can be determined polarisation resolved or wavelength resolved. Alternatively, the radiation detector 90 can also be designed to be polarisation selective or wavelength selective.

In an embodiment according to the invention the optical measurement apparatus 50 in a suitable configuration is used to determine the telecentricity of the projection objective 18 and/or of an imaging module of the illumination system 12 of interest. This way telecentricity errors can be detected and evaluated.

In a further embodiment according to the invention the optical measurement apparatus 50 is used to measure scattered light portions within the exposure radiation 16. This can e.g. be performed by inserting an opaque object into the reticle plane 14 and determining the intensity of the radiation in the optical path of the opaque object at a location after the projection objective 18.

A further property to be measured may be the amount of speckle within the projection exposure system 10. Further, a measurement of micro-uniformity of the lithographic exposure may be performed. According to a further embodiment the optical measurement apparatus 50 is used to perform a scattered light measurement at the projection exposure system 10.

The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

1. An optical measurement apparatus for a projection exposure system for microlithography comprising:
an optical sensor configured to measure a property of exposure radiation within the projection exposure system and a data interface configured to transmit the measured property as measurement data to a data receiver separated from and disposed external to the measurement apparatus at least during the measuring operation,
wherein the optical measurement apparatus has an exterior form of a reticle.

2. The optical measurement apparatus according to claim 1,
wherein the data interface is configured as a data transmitter for contact-free transmission of the measurement data.

3. The optical measurement apparatus according to claim 2,
wherein the data transmitter comprises a radio transmitter.

4. The optical measurement apparatus according to claim 2,
wherein the data transmitter is configured to transmit the measurement data via a sequence of different magnetic field strengths to the data receiver disposed in the near field of the magnetic field. data.

5. The optical measurement apparatus according to claim 2,
wherein the data transmitter comprises a sound source.

6. The optical measurement apparatus according to claim 1,
further comprising a data memory configured to store the measurement

7. The optical measurement apparatus according to claim 1,
wherein the data interface is configured as a contact interface.

8. The optical measurement apparatus according to claim 1,
further comprising a current source.

9. The optical measurement apparatus according to claim 8,
wherein the current source comprises an energy receiver configured to receive energy transmitted contact-free.

10. The optical measurement apparatus according to claim 1,
wherein the optical sensor is configured to determine an intensity of the irradiated exposure radiation, directionally resolved.

11. The optical measurement apparatus according to claim 1,
wherein the optical sensor is configured as a polarization sensor.

12. The optical measurement apparatus according to claim 1,
wherein the optical sensor is configured as a detector of exposure radiation within the extreme ultraviolet wavelength range.

13. The optical measurement apparatus according to claim 1,
further comprising a signal receiver configured to receive control signals transmitted contact-free from outside of the optical measurement apparatus for controlling the measurement apparatus.

14. A measuring system comprising the optical measurement apparatus according to claim 1 and the data receiver disposed external to the measurement apparatus.

15. A projection exposure system for microlithography comprising the measurement apparatus according to claim 1.

16. The projection exposure system according to claim 15,
wherein the measurement apparatus is disposed in an optical path of the projection exposure system guiding the exposure radiation.

17. A method of performing an optical measurement in a projection exposure system for microlithography, which comprises a wafer plane and an optical path for guiding exposure radiation onto a wafer arranged in the wafer plane, which method comprises:
arranging a cordless optical measurement apparatus within the optical path of the projection exposure system at a position above the wafer plane, which optical measurement apparatus comprises an optical sensor and a data interface,
measuring a property of the exposure radiation within the projection exposure system with the optical sensor, and
transmitting the property measured as measurement data via the data interface to a data receiver disposed external to the measurement apparatus at least during the measuring operation.

18. The method according to claim 17,
wherein the projection exposure system comprises an illumination system for illuminating a mask to be imaged into the wafer plane, and the optical measurement apparatus is arranged inside the illumination system.

19. The method according to claim 17,
wherein the arranging of the optical measurement comprises exchanging a mechanically exchangeable optical element in the optical path of the projection exposure system with the optical measurement apparatus.

20. The method according to claim 17,
wherein the measurement data are transmitted, contact-free, to the data receiver via the data interface.
